(19) United States
(12) Patent Application Publication
(10) Pub. No.: US 2007/0171222 A1
(43) Pub. Date: Jul. 26, 2007

(54) Application-independent method for capturing three-dimensional model data and structure for viewing and manipulation

(75) Inventor: Jeffrey M. Kowalski, Berkeley, CA (US)

Correspondence Address: GATES & COOPER LLP, HOWARD HUGHES CENTER, 6701 CENTER DRIVE WEST, SUITE 1050, LOS ANGELES, CA, 90045, US

(73) Assignee: Autodesk, Inc.

(21) Appl. No.: 11/337,755

(22) Filed: Jan. 23, 2006

(51) Int. Cl. G06T 17/00

(52) U.S. Cl. 345/420

(57) ABSTRACT

A computer-implemented method, apparatus and article of manufacture for capturing three-dimensional (3D) model data and structure maintained by a computer-implemented graphics program for display and manipulation. Calls made by the graphics program to a graphics library for displaying and manipulating the 3D model data are captured, and the captured calls are translated into a structure associated with the 3D model data, wherein the structure is saved for subsequent display and manipulation. The structure associated with the 3D model data comprises an assembly hierarchy associated with the 3D model data, wherein the assembly hierarchy is comprised of one or more parts and a hierarchical organization of the parts.

### BACKGROUND OF THE INVENTION

1. Field of the Invention

The present invention relates generally to computer-assisted design systems, and in particular, to an application-independent method for capturing three-dimensional model data and structure for viewing and manipulation.

2. Description of the Related Art

Programs such as ADOBE ACROBAT seek to provide application-independent platforms for viewing and marking up documents. This has been accomplished by capturing text and graphic data through special printer-drivers, which take the information sent to a print stream, save it and make it accessible, as two-dimensional (2D) documents, to these programs. This is a relatively straightforward process, as print information is inherently 2D, and simply requires the capture and reformatting of the print stream.

However, in for computer-assisted drafting (CAD) and computer-assisted manufacturing (CAM) systems, most information is inherently derived from three-dimensional (3D) model data. What users really want is to be able to not only capture 2D plans and graphics, but to also capture the 3D model data, and be able to view it and manipulate it within a viewing program such as AUTODESK DWF COMPOSER.

However, the capture of 3D model data in an application-independent way is challenging. Several programs, such as glTrace and glAnalyse, which are used with the OpenGL graphics standard, accomplish this task by a process known as “shimming.”

Shimming refers to the insertion of computer code between two layers of a composed program, wherein the shim is a functional unit of code that can be used to perform alternative operations beyond what the original program intended, while potentially still preserving the functions of the original program. For example, a shim may intercept OpenGL calls to video drivers and save the OpenGL calls to a file, so that the OpenGL calls may then be opened and/or manipulated.

One major drawback of the shimming approach provided by glTrace and glAnalyse is that structural information within the 3D model data is typically lost. The portions of the 3D model data captured by the shim typically contain only the basic elements of the 3D model data needed for display (such as points, triangles, etc.).

The3D model data representing a telephone, for example, may comprise an assembly having a number of different sub-assemblies that may include the handset, base, and internal electrical components. In this context, assemblies and sub-assemblies are conceptual groupings or containers. Users typically want to be able to turn these groupings on and off, to inspect them individually, to rotate and translate individual groupings, etc.

Consequently, there is a need in the art for a mechanism by which the “shimming” technique is extended to recognize structural information within the captured 3D model data, and make this information available to a viewing program, such as the AUTODESK DWF COMPOSER. The present invention satisfies that need.

### SUMMARY OF THE INVENTION

To overcome the limitation in the prior art described above, and to overcome other limitations that will become apparent upon reading and understanding the present specification, the present invention describes a computer-implemented method, apparatus and article of manufacture for capturing three-dimensional (3D) model data and structure maintained by a graphics program for display and manipulation. Calls made by the graphics program to a graphics library for displaying and manipulating the 3D model data are captured, and the captured calls are translated into a structure associated with the 3D model data, wherein the structure is saved for subsequent display and manipulation. The structure associated with the 3D model data comprises an assembly hierarchy associated with the 3D model data, wherein the assembly hierarchy is comprised of one or more parts and a hierarchical organization of the parts.

### BRIEF DESCRIPTION OF THE DRAWINGS

Referring now to the drawings in which like reference numbers represent corresponding parts throughout:

FIG. 1 is an exemplary hardware and software environment used to implement the preferred embodiment of the invention;

FIG. 2 is a block diagram that illustrates the processing of OpenGL commands according to the preferred embodiment of the present invention;

FIG. 3 is a block diagram that illustrates the logic used for matrix stack processing according to the preferred embodiment of the present invention; and

FIG. 4 is a flowchart that illustrates the general logic performed according to the preferred embodiment of the present invention.

### DETAILED DESCRIPTION OF THE PREFERRED EMBODIMENTS

In the following description, reference is made to the accompanying drawings which form a part hereof, and which is shown, by way of illustration, an embodiment of the present invention. It is understood that other embodiments may be utilized and structural changes may be made without departing from the scope of the present invention.

Overview

The present invention is an application-independent method for capturing 3D model data for display and manipulation. Specifically, the present invention provides a “shimming” technique that recognizes a structure within the captured 3D model data, and saves this structure for subsequent display and manipulation.

Hardware and Software Environment

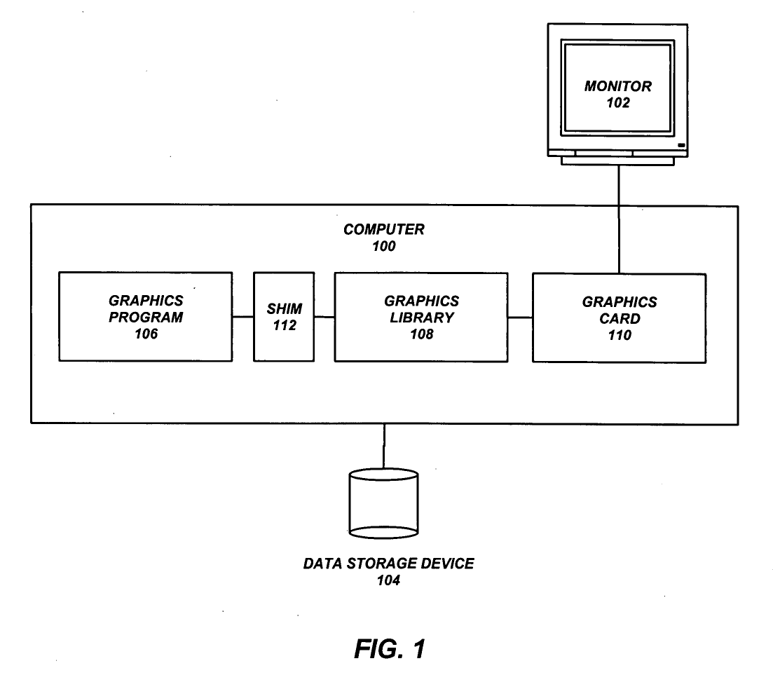

FIG. 1 is an exemplary hardware and software environment used to implement the preferred embodiment of the invention. The preferred embodiment of the present invention is typically implemented using a computer 100, which generally includes, inter alia, a monitor 102, data storage devices 104, and other devices. Those skilled in the art will recognize that any combination of the above components, or any number of different components, peripherals, and other devices, may be used with the computer 100.

In the exemplary hardware and software environment, a computer-implemented graphics program 106 interfaces to a graphics library 108, which in turn transmits a datastream of commands and data to a video card 110, in order to display information on the monitor 102, wherein the information displayed on the monitor 102 is derived from a assembly hierarchy of 3D model data maintained by the graphics program 106. The preferred embodiment of the present invention is implemented by a shim 112 that captures the calls made by the graphics program 106 to the graphics library 108 and stores the resulting data in a file on the data storage device 104, for use later by the graphics program 106 or by other programs. Specifically, the shim 112 captures and stores information about the assembly hierarchy of the 3D model data maintained by the graphics program 106, for subsequent viewing, manipulation and conversion into other formats.

Generally, the graphics program 106, graphics library 108 and shim 112 all comprise logic and/or data embodied in or readable from a device, media, or carrier, e.g., one or more fixed and/or removable data storage devices 104 connected directly or indirectly to the computer 100, one or more remote devices coupled to the computer 100 via data communications devices, etc. Thus, the graphics program 106, graphics library 108 and shim 112 may be implemented as a method, apparatus or article of manufacture.

Of course, those skilled in the art will recognize that the exemplary environment illustrated in FIG. 1 is not intended to limit the present invention. Indeed, those skilled in the art will recognize that other alternative environments may be used without departing from the scope of the present invention.

The OpenGL Standard

In one embodiment, the assembly hierarchy of the 3D model data maintained by the graphics program 106 is based on the OpenGL standard. The OpenGL standard is a hardware-independent software interface that is implemented for many different types of graphics hardware, e.g., video cards 110. The main purpose of OpenGL is to render 2D and 3D objects into a frame buffer used by the video card 110.

The OpenGL standard does not provide commands for performing windowing tasks or obtaining user input. Similarly, OpenGL does not provide high-level commands for describing the 3D model data. Instead, the OpenGL standard is comprised of a plurality of commands that are used to specify the geometric objects and operations needed to produce interactive graphics applications.

In OpenGL, the 3D model data is typically generated using a small set of geometric primitives, such as points, lines, and polygons. These primitives are defined by pixels (which define images) or sequences of vertices (which define geometric objects).

For example, a vertex may define a point, an endpoint of a line, or a comer of a polygon where two edges meet. Data, such as vertex coordinates, colors, normals, texture coordinates, and edge flags, is associated with each vertex, and each vertex and its associated data are processed independently, in order, and in the same way.

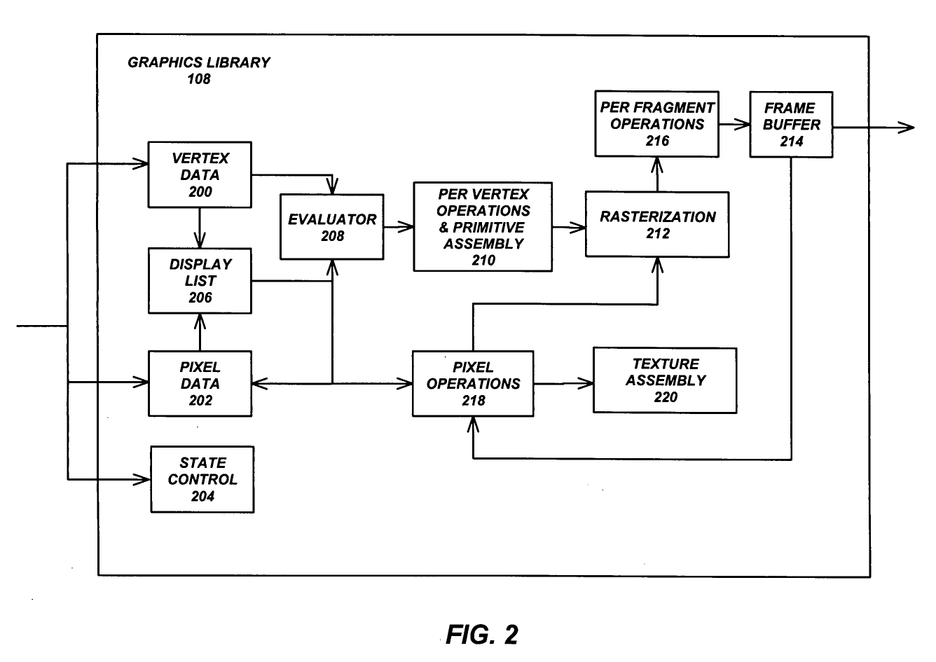

FIG. 2 is a block diagram that illustrates the processing of OpenGL commands by the graphics library 108 according to the preferred embodiment of the present invention.

The input to the graphics library 108 includes OpenGL commands for both vertex data 200 and pixel data 202. Further, the graphics library 108 includes a state control 204.

Generally, OpenGL commands are processed in a “pipeline” manner, although some of the commands can be accumulated in a display list 206 for processing at a later time.

In most implementations, the pipeline processing includes the following:

1. An evaluator stage 208 that approximates curve and surface geometry by evaluating polynomial commands of input values.

2. A per-vertex operations and primitive assembly stage 210, where geometric primitives, e.g., points, line segments, and polygons, all of which are described by vertices, are processed. This stage includes steps where vertices are transformed and lit, and primitives are clipped to the viewport in preparation for the next stage.

3. A rasterization stage 212 is the process by which a primitive is converted to a 2D image. The rasterization stage 212 produces a series of frame buffer 214 addresses and associated values using a 2D description of a point, line segment, or polygon. Specifically, primitives are converted to pixel fragments in several steps: primitives are clipped appropriately, whatever corresponding adjustments are necessary are made to the color and texture data, and the relevant coordinates are transformed to window coordinates. Finally, the rasterization stage 212 converts the clipped primitives to pixel fragments.

4. Each fragment so produced is fed into the last stage, a per-fragment operations stage 216, which performs the final operations on the data before it is stored as pixels in a frame buffer 214. These operations include conditional updates to the frame buffer 214, and the blending of incoming pixel colors with stored colors, as well as masking and other logical operations on pixel values.

5. As noted above, input data can be in the form of pixels rather than vertices. Such data, which might describe an image for use in texture mapping, skips the first and second stages 208, 210 of processing described above and instead is processed as pixels, in a pixel operations stage 218. The result of this stage 218 is either stored as texture memory 220, or rasterized and the resulting fragments merged into the frame buffer 214.

In OpenGL, transformations are used to render the 3D model data for display: viewing transformation, modeling transformation, projection transformation, and viewport transformation. These commands are passed to the state control 204.

To specify viewing, modeling, and projection transformations, transformation data comprised of a 4×4 matrix M is constructed, which is then multiplied by the coordinates of each vertex v in the 3D model data to accomplish the transformation:
v′=Mv

The viewing and modeling transformations specified are combined to form a modelview matrix, which is applied to the incoming object coordinates to yield eye coordinates. Thereafter, a projection matrix is applied to define a viewing volume, wherein objects outside this volume are clipped, so that they are not displayed. Finally, the transformed coordinates are converted to window coordinates by applying the viewport transformation, wherein the dimensions of the viewport can be manipulated to cause the final display to be enlarged, shrunk, or stretched.

The OpenGL standard provides a number of commands for matrix transformations. These commands include gIMatrixMode( ), glMultMatrix( ), glRotate( ), glTranslate( ), and glScale( ), which are used to compose the desired transformations, or matrices can be specified directly with glLoadMatrix( ) and glLoadldentity( ).

The OpenGL standard also provides a stack for the modelview and projection matrices. In gl_ModelView mode, the stack depth is at least 32. In gl_Projection mode, the depth is at least 2. The current matrix in any mode is the matrix on the top of the stack for that mode.

The commands glPushMatrix( ) and glPopMatrix( ) are used to save and restore modelview and projection matrices on their respective stacks. The command glPushMatrix pushes the current matrix stack down by one, duplicating the current matrix, so that, after a glPushMatrix call, the matrix on the top of the stack is identical to the one below it. The command glPopMatrix pops the current matrix stack, replacing the current matrix with the one below it on the stack. Initially, each of the stacks contains one matrix, an identity matrix.

Operation of the Shim

The shim 112 is a driver that is implemented so that it corresponds to all application programming interface (API) entry points in the graphics library 108. The shim 112 is then interposed between the graphics program 106 and the graphics library 108 in order to capture calls made by the graphics program 106 to the graphics library 108.

The installation process involves either renaming the original graphics library 108 and replacing it with the shim 112, or installing the shim 112 in the local directory of the graphics program 106. By virtue of the library loading process in the operating system, the shim 112 is loaded in place of the graphics library 108 without need to modify the graphics program 106. The shim 112, as it is loaded, subsequently privately loads the “real” graphics library 108, but shields it from the graphics program 106.

In an alternative embodiment, it is also possible to “inject” the shim 112 directly into a running graphics program 106. For example, the shim 112 may be injected by locating the process associated with the graphics program 106 in the memory of the computer 100, accessing that portion of the memory, and rewriting a function pointer table in that accessed portion of the memory to point at API entry points in the shim 112, rather than API entry points in the graphics library 108.

In either method, calls made by the graphics program 106 to the API entry points meant for the graphics library 108 for displaying and manipulating the 3D model data are captured by the shim 112. The shim 112 saves the captured calls, along with the associated data, in a file for subsequent display or manipulation, and then passes the captured calls, along with the associated data, directly on to the graphics library 108, so that the display on the monitor 102 is properly updated as expected.

In addition, the captured calls are translated by the shim 112 into a structure associated with the 3D model data, wherein the structure comprises an assembly hierarchy comprised of one or more parts and a hierarchical organization of the parts. Each part is comprised of one or more geometric objects, and the hierarchical organization is represented by a tree structure with an arbitrary number of child nodes (either assemblies or parts) at any level with an arbitrary tree depth.

In this regard, the translation performed by the shim 112 extracts geometric and structure information from the captured calls to identify the structure and contents of the 3D model data maintained by the graphics program 106. Geometric information is extracted from the captured calls by examining vertex calls and begin/end instructions that delimit geometric objects such as triangle strips, quads, and fans. Corresponding attribute information (including ambient characteristics such as color, or vertex decorations such as texture coordinates) are recorded by examining related commands.

However, vertex calls, begin/end instructions and corresponding attribute information are insufficient to describe the 3D model data in terms of its structure. Consequently, the shim 112 includes structure-extracting functions that identify the structure of the 3D model data from the captured calls. Specifically, the translation performed by the shim 112 extracts transformation data from the captured calls to identify the structure of the 3D model data maintained by the graphics program 106.

The extracting performed by the shim 112 is predicated on transformation-coherence, wherein a single part within the assembly hierarchy is defined by a plurality of geometric objects subject to the same transformation data. Inversely, a plurality of geometric objects that share the same transformation data are presumed to represent the same part, which is used to identify part boundaries.

In the OpenGL standard, the current transformation matrix must be maintained to draw geometric objects at the proper location. Moreover, each child occurrence in the assembly hierarchy typically has its own modeling transformation that must be set before its geometric objects are drawn. Thus, a modeling transformation is typically defmed as a transformation from the local part coordinates to the parent coordinates. Therefore, due to transformations being relative, before the transformation for the next child occurrence is applied, the transformation for the current assembly must be restored.

Another aspect of the present invention, related to the structure-extracting functions, relies on the observation that the graphics program 106 typically displays parts using a serial depth-first traversal of the assembly hierarchy. Thus, the translation performed by the shim 112 also identifies the parts from a serial depth-first traversal of the assembly hierarchy by the graphics programs.

With this knowledge, the shim 112 re-constructs the assembly hierarchy of the 3D model data maintained by the graphics program 106 by examining the structure inherent in the OpenGL API calls made by the graphics program 106 and captured by the shim 112. In particular, the shim 112 looks for commands for matrix transformations, because the transformation data defines a transformation in coordinates. Thus, the transformation data comprises a transformation matrix stored in a matrix stack.

As a result, changes in the matrix stack represent an assembly boundary, and the assembly hierarchy of the 3D model data is captured by recording the changes in the matrix stack, wherein the changes in the matrix stack are represented by captured calls for matrix transformations made by the graphics program to the graphics library.

When the captured calls for matrix transformations include a “push” operation (i.e., a “glPushMatrix” command), this captured call indicates that the graphics program 106 is descending into the assembly hierarchy prior to describing a new constituent part. Similarly, when the captured calls for matrix transformations include a “pop” operation (i.e., a “glPopMatrix” command), this captured call indicates that the graphics program 106 is ascending from a constituent part up through the assembly hierarchy.

Recording these state changes in a hierarchical fashion allows the shim 112 to capture the assembly hierarchy of the 3D model data maintained by the graphics program 106, in addition to the geometric objects as described above. Moreover, the shim 112 can capture both together, with the geometric objects existing in context of the assembly hierarchy.

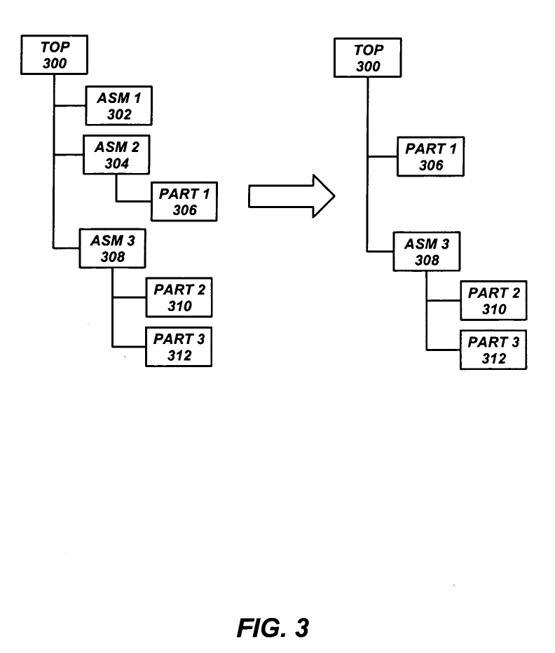

FIG. 3 is a block diagram that illustrates the logic used for matrix stack processing according to the preferred embodiment of the present invention. The shim 112 maintains a modelview stack (a “last in, first out” or LIFO structure) in order to facilitate re-creation of tree iterations in the assembly hierarchy. A current matrix can be pushed into the stack, multiplied by the relative transformation and then restored from the stack to continue the tree iteration.

In FIG. 3, the left tree represents the OpenGL assembly hierarchy and the right tree represents the resulting shim 112 assembly hierarchy. Both trees include a top or root node 300. The left tree includes an empty first assembly (ASM 1) node 302, a second assembly (ASM 2) node 304 including a first part (PART 1) 306, and a third assembly (ASM 3) node 308 including a second part (PART 2) 310 and a third part (PART 3) 312. The left tree is translated into the right tree that includes a first part (PART 1) 306, and a third assembly (ASM 3) node 308 including a second part (PART 2) 310 and a third part (PART 3) 312.

The stack processing includes the following steps:
Track the current stack level, wherein a “push” operation increases the current stack level, while a “pop” operation decreases the current stack level;
Additionally, end the current assembly on the occurrence of a “pop” operation;
When a geometric object (e.g., a primitive) is captured, create as many new assemblies as necessary to match the current stack level;
Recursive or “nested” wrappings of a geometric object within multiple levels of push-pop brackets can be assumed redundant and therefore removed if there is no other intervening geometry between push or pop calls. As a simplified example, interpreting “(“as “push” and ”)” as “pop”, the stream “(((geom))( )(( )))” may all be simplified to “(geom)”.

The reason for performing assembly creation only when a geometric object is captured is to provide a mechanism for skipping empty assemblies that could be introduced due to unrelated stack manipulations. Controlling geometric objects also allows the shim 112 to skip “extra” assemblies that could appear due multiple stack operations for an assembly level and remove assembly levels with just a single child, as shown in the example of FIG. 3.

Note that the shim 112 may also use additional heuristics for part identification, including changes in material and representational properties of geometric objects.

For example, a plurality of geometric objects that share one or more material and representational properties typically represent a single part, wherein the properties include materials, textures, patterns or visibility states. Thus, if the same changes are made in material and representational properties to different geometric objects, this information can be used to identify part boundaries.

Another marker for object boundaries is the use of a stack that manages attributes via push/pop (e.g., the glPushAttrib and glPopAttrib commands). Therefore, the shim 112 looks not only at raw attribute changes, but also employs a method similar to one used to track push/pop of matrices.

Finally, the shim 112, having collected and organized geometric objects into assembly hierarchy, can then output and save the captured information to relevant formats. These formats may include DWF, or other formats, as desired. Moreover, the tags may be added to the exported data to add functionality or identify the source of the model.

### Logic of the Preferred Embodiment

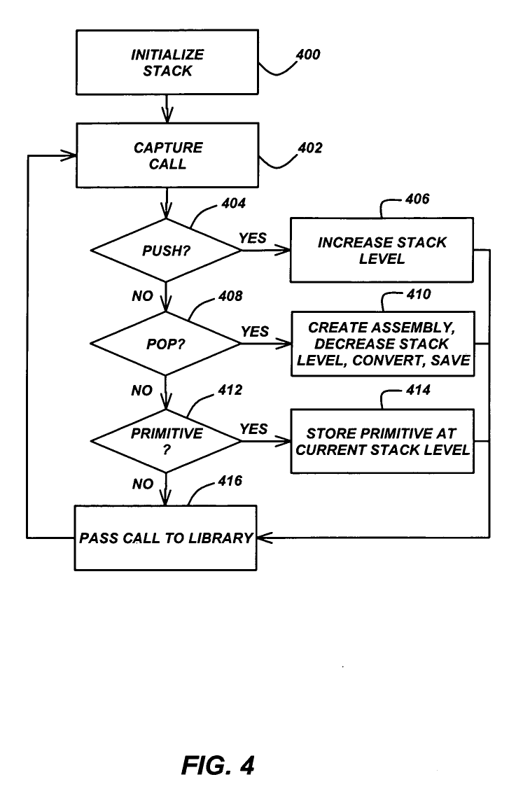

FIG. 4 is a flowchart that illustrates the general logic performed according to the preferred embodiment of the present invention. Those skilled in the art will recognize that this logic is provided for illustrative purposes only and that different logic may be used to accomplish the same results.

Block 400 represents the shim 112 initializing the stack, as well as a tree structure, including the creation of the top node 300.

Block 402 represents the shim 112 capturing an OpenGL call made by the graphics program 108. The following Blocks 404-416 represent the translation of the captured calls.

Block 404 is a decision block that represents the shim 112 determining whether the captured OpenGL call made by the graphics program 108 is a “push” operation. If so, control transfers to Block 406; otherwise, control transfers to Block 408.

Block 406 represents the shim 112 increasing the stack level and clearing a primitive list at the new stack level. Thereafter, control transfers to Block 416.

Block 408 is a decision block that represents the shim 112 determining whether the captured OpenGL call made by the graphics program 108 is a “pop” operation. If so, control transfers to Block 410; otherwise, control transfers to Block 412.

Block 410 represents the shim 112 performing the following steps: (1) creating an assembly from primitives stored on the primitive list; (2) converting the OpenGL command into another language or format (for example, this Block may represent the shim 112 converting the OpenGL command into the AUTODESK DWF format); ( 3) saving the OpenGL command (either in its native format and/or in the converted format), the hierarchy assembly, as well as other context information, including tags that are added to the exported data to add functionality or identify a source of the 3D model data; and (4) decreasing the stack level. Thereafter, control transfers to Block 416.

Block 412 is a decision block that represents the shim 112 determining whether the captured OpenGL call made by the graphics program 108 is a primitive operation. If so, control transfers to Block 414; otherwise, control transfers to Block 416.

Block 414 represents the shim 112 storing the primitive in the primitive list at the current stack level. Thereafter, control transfers to Block 416.

Block 416 represents the shim 112 passing the OpenGL command to the graphics library 108 for execution.

Thereafter, control transfers back to Block 402.

### Conclusion

This concludes the description of the preferred embodiment of the invention. The following describes some alternative embodiments for accomplishing the present invention.

For example, any type of computer could be used with the present invention. In addition, any program, function, or system providing 3D model data could benefit from the present invention. Moreover, although OpenGL is described herein, the present invention could also be applied to DirectX, or any other graphics standard.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method for capturing three-dimensional ( 3D) model data and structure maintained by a graphics program for display or manipulation, comprising:
(a) capturing calls made by a graphics program to a graphics library for displaying or manipulating the 3D model data; and
(b) translating the captured calls into a structure associated with the 3D model data, wherein the structure is saved for subsequent display or manipulation.

2. The method of claim 1, wherein the structure associated with the 3D model data comprises an assembly hierarchy associated with the 3D model data, wherein the assembly hierarchy is comprised of one or more parts and a hierarchical organization of the parts.

3. The method of claim 2, wherein the translating step comprises extracting transformation data from the captured calls to identify the structure of the 3D model data maintained by the graphics program.

4. The method of claim 3, wherein the extracting step is predicated on transformation-coherence, wherein a single part within the assembly hierarchy is defined by a plurality of geometric objects subject to the same transformation data.

5. The method of claim 3, wherein the extracting step comprises identifying one or more parts from a serial depth-first traversal of the assembly hierarchy by the graphics programs.

6. The method of claim 3, wherein the transformation data comprises a transformation matrix stored in a matrix stack and changes in the matrix stack represent an assembly boundary, such that the assembly hierarchy of the 3D model data is captured by recording the changes in the matrix stack represented by captured calls for matrix transformations made by the graphics program to the graphics library.

7. The method of claim 6, wherein the captured calls for matrix transformations include a “push” operation that indicates that the graphics program is descending into the assembly hierarchy prior to describing a new constituent part and a “pop” operation that indicates that the graphics program is ascending from a constituent part up through the assembly hierarchy.

8. The method of claim 2, wherein a plurality of geometric objects that share one or more properties represent a single part.

9. The method of claim 1, wherein the translating step further comprises extracting geometric information from the captured calls by examining vertex calls and begin/end instructions that delimit geometric objects.

10. The method of claim 1, wherein tags are added to exported data to identify a source of the 3D model data.

11. An apparatus for capturing three-dimensional ( 3D) model data and structure maintained by a graphics program for display or manipulation, comprising:
(a) a computer; and
(b) logic, performed by the computer, for:
(1) capturing calls made by a graphics program to a graphics library for displaying or manipulating the 3D model data; and
(2) translating the captured calls into a structure associated with the 3D model data, wherein the structure is saved for subsequent display or manipulation.

12. The apparatus of claim 11, wherein the structure associated with the 3D model data comprises an assembly hierarchy associated with the 3D model data, wherein the assembly hierarchy is comprised of one or more parts and a hierarchical organization of the parts.

13. The apparatus of claim 12, wherein the logic for translating comprises logic for extracting transformation data from the captured calls to identify the structure of the 3D model data maintained by the graphics program.

14. The apparatus of claim 13, wherein the logic for extracting is predicated on transformation-coherence, wherein a single part within the assembly hierarchy is defined by a plurality of geometric objects subject to the same transformation data.

15. The apparatus of claim 13, wherein the logic for extracting comprises logic for identifying one or more parts from a serial depth-first traversal of the assembly hierarchy by the graphics programs.

16. The apparatus of claim 13, wherein the transformation data comprises a transformation matrix stored in a matrix stack and changes in the matrix stack represent an assembly boundary, such that the assembly hierarchy of the 3D model data is captured by recording the changes in the matrix stack represented by captured calls for matrix transformations made by the graphics program to the graphics library.

17. The apparatus of claim 16, wherein the captured calls for matrix transformations include a “push” operation that indicates that the graphics program is descending into the assembly hierarchy prior to describing a new constituent part and a “pop” operation that indicates that the graphics program is ascending from a constituent part up through the assembly hierarchy.

18. The apparatus of claim 12, wherein a plurality of geometric objects that share one or more properties represent a single part.

19. The apparatus of claim 1 1, wherein the logic for translating further comprises logic for extracting geometric information from the captured calls by examining vertex calls and begin/end instructions that delimit geometric objects.

20. The apparatus of claim 11, wherein tags are added to exported data to identify a source of the 3D model data.

21. An article of manufacture embodying logic for capturing three- dimensional (3D) model data and structure maintained by a graphics program for display or manipulation, the logic comprising:
(a) capturing calls made by a graphics program to a graphics library for displaying or manipulating the 3D model data; and
(b) translating the captured calls into a structure associated with the 3D model data, wherein the structure is saved for subsequent display or manipulation.

22. The article of claim 21, wherein the structure associated with the 3D model data comprises an assembly hierarchy associated with the 3D model data, wherein the assembly hierarchy is comprised of one or more parts and a hierarchical organization of the parts.

23. The article of claim 22, wherein the translating step comprises extracting transformation data from the captured calls to identify the structure of the 3D model data maintained by the graphics program.

24. The article of claim 23, wherein the extracting step is predicated on transformation-coherence, wherein a single part within the assembly hierarchy is defined by a plurality of geometric objects subject to the same transformation data.

25. The article of claim 23, wherein the extracting step comprises identifying one or more parts from a serial depth-first traversal of the assembly hierarchy by the graphics programs.

26. The article of claim 23, wherein the transformation data comprises a transformation matrix stored in a matrix stack and changes in the matrix stack represent an assembly boundary, such that the assembly hierarchy of the 3D model data is captured by recording the changes in the matrix stack represented by captured calls for matrix transformations made by the graphics program to the graphics library.

27. The article of claim 26, wherein the captured calls for matrix transformations include a “push” operation that indicates that the graphics program is descending into the assembly hierarchy prior to describing a new constituent part and a “pop” operation that indicates that the graphics program is ascending from a constituent part up through the assembly hierarchy.

28. The article of claim 22, wherein a plurality of geometric objects that share one or more properties represent a single part.

29. The article of claim 21, wherein the translating step further comprises extracting geometric information from the captured calls by examining vertex calls and begin/end instructions that delimit geometric objects.

30. The article of claim 21, wherein tags are added to exported data to identify a source of the 3D model data.
